(19) United States
(12) Patent Application Publication
(10) Pub. No.: US 2010/0282707 A1
(43) Pub. Date: Nov. 11, 2010

(54) STOPPER CAPSULE WITH MULTILAYER JOINT

(75) Inventors: Jacques Granger, Saint Terre (FR); Jean-Marie Bourreau, Le Pizou (FR)

Correspondence Address: DENNISON, SCHULTZ & MACDONALD, 1727 KING STREET, SUITE 105, ALEXANDRIA, VA, 22314, US

(73) Assignee: ALCAN PACKAGING CAPSULES, Courbevoie (FR)

(21) Appl. No.: 12/445,665

(22) PCT Filed: Oct. 24, 2007
(86) PCT No.: PCT/FR07/01759

§ 371 Date: Apr. 15, 2009

(30) Foreign Application Priority Data
Oct. 24, 2006 (FR) 0609289

(51) Int. Cl. B65D 41/04; B65D 53/00; B23P 11/00

(52) U.S. Cl. 215/329; 215/347; 29/428

(57) ABSTRACT

A stopper cap and method for its manufacture, the stopper cap including a shell with a head, a skirt and a seal, in which the seal is a form seal, and the form seal has a resilient layer and a set of adjacent layers. The adjacent layers include a barrier layer, a malleable support layer to provide the adjacent layers a global malleable property such that the seal can be shaped without creation of folds, and an outer layer having an outer surface which can be compressed by the axial compression resulting from stoppering so as to match the form of the mouth of the neck.

### SCOPE OF THE INVENTION

The invention concerns the field of capping recipients, typically bottles, for containing liquids over several years, typically beverages, which are sensitive to oxidation, effervescent or otherwise, or even packaged under pressure. It concerns the field of stopper caps suitable for guaranteeing a sufficient gas tightness seal between the interior and exterior of the recipient. More particularly it concerns screw type stopper caps cooperating with a threaded neck of the recipient such that the capsules can be screwed and unscrewed.

### BACKGROUND OF RELATED ART

A large number of stopper caps are already known for so-called non carbonated liquids or so-called still liquids (CO₂ content less than 1.2 g/l). These is capsules often comprise an add-on seal adapted to the stopping of bottles, the liquid content of which, not sensitive to oxidation, is maintained at a pressure near atmospheric pressure.

Stopping means are also known for liquid under pressure, such as Champagne wines, comprising a cork stopper with head which is secured to the neck by means of a wire cage. In this case, it is not possible or easy to restop the neck with the cork.

Stopper caps are also known for maintaining the pressure owning to a compounded liner formed by a PVC based “compound” or mixture.

### PROBLEMS POSED

Several types of problems are posed in the field of tight capsules.

Conventional seals do not enable a liquid and gas tightness to be obtained, in particular with pressures inside the recipient ranging from 10 bar to 15 bar, i.e. from 1 MPa to 1.5 MPa, for a temperature range typically from 0° C. to 50° C., and for a period of possibly several years or even several decades.

Regarding the compounded liners, the PVC-based compound habitually used comprised at least a plasticizer such as DOP (dioctylphtalate) whose use is now prohibited by law in the European Union. Substitution plasticizers such as DEHP (di-ethylhexylphtalate) pose other problems as they require special equipment to implement them, their use thus resulting in costly investments. DEHPs are also on the point of being prohibited by law.

Furthermore, improving the seal must not result in downgrading the easiness by which the capsule is opened. In particular, when a screw type capsule is concerned, manual unscrewing must be performed with a torque within the standard range typically from 0.1 N·m (minimum for a capsule of 16 mm in diameter) to 3 N·m (maximum for a capsule of 41 mm in diameter), which corresponds to a standard manual force. Furthermore, it would be of no use to have a recipient with a hermetic seal with good pressure resistance it was then very difficult to open or if doing so would require special tools such as pliers.

### DESCRIPTION OF THE INVENTION

According to the invention, the stopper cap, having an axial direction, comprises a shell, with a skirt and a head essentially perpendicular to said axial direction, and a seal arranged inside said shell, typically against the internal surface of said head, said stopper cap being designed to hermetically plug the neck of a recipient, typically a bottle, by axial and lateral compression of said capsule and said seal against said neck. Said capsule is characterized in that:
a) said seal is a form seal, typically a form seal added on under stress, for example pressed into the bottom of the shell by force, against the internal surface of the head, said seal presenting a center part, typically flat and perpendicular to said axial direction, surrounded by an axial peripheral edge, the axial height h of which, measured between the level of the internal surface of said center part and the end of said peripheral edge is at least equal to ¼ the thickness of said center part, preferably between 25% and 100% of said thickness. This axial height is typically between 0.5 and 2 mm.
b) said form seal is a multilayer seal comprising at least:
   b1) a resilient layer made of a material capable of sustaining extensive deformation under compression while remaining in its elastic range, typically an expanded polymeric material, an expanded polystyrene (EPS), an expanded polypropylene (EPP) or, preferably, an expanded polyethylene (EPE) or even an elastomeric material, typically a polymer comprising butyl or nitrile groups, or a thermoplastic elastomer such as SIS (styrene isoprene styrene), SBS (styrene butadiene styrene) or SEBS (styrene ethylene/butylene styrene);
   b2) a set of adjacent layers, comprising at least the following layers, with a same layer possibly fufilling more than one of the functions described below:
      b2.1) a layer made of a material to form a barrier to the diffusion of gases, said material being a metal such as aluminum or tin or their respective alloys, an organic material such as polyvinylidene chloride (PVDC), particularly a Saran (registered trademark of Dow Chemical Company), or a copolymer (ethylene vinyl alcohol) (EVOH) or yet a mineral material such as silicium oxide (SiOx);
      b2.2) a malleable support layer for providing said set of adjacent layers a global malleable mechanical property, enabling, in association with said resilient layer, said form seal to be shaped without the creation of folds. The layer may consist of a material such as a metal or metal alloy, typically aluminum, steel or tin, or a thermoplastic material such as polyolefine (PE, PP), a polyethylene terephtalate (PET) or a polyamide (PA);
      b2.3) an outer layer made of plastic material with the function of presenting an outer surface for indentation under the effect of said axial compression of said capsule and of said seal against said neck so as to match, at the contact, the form of the mouth of said neck.

Said outer layer is placed in contact with the mouth of the neck of the recipient. This layer consists made of a deformable plastic material so that its surface is, during stoppering, indented by the mouth of the neck which is made of a clearly more rigid material, such as glass, and that it continues, after stoppering, to match the surface relief of said mouth under the influence of axial compression resulting from the stoppering and crimping. In order to enable easy removal of the capsule, the material of said outer layer advantageously forms with the material of the recipient, a contact with a low friction coefficient, typically a Coulomb coefficient less than 0.25, preferably less than 0.2. Typically, this material is made of a polyamide or polyethylene, is advantageously loaded with a slip additive.

This combination of means resolves the problems posed. Furthermore, the applicant was able to observe that these means enabled an excellent liquid and gas tightness to be obtained, and are particularly advantageous for the stopping means of liquids under pressure as they enable excellent resistance to pressure to be obtained.

According to a hypothesis proposed by the applicant, the form seal according to the invention would be fold free, very probably owing to the presence of the malleable support layer within the set of adjacent layers, which is difficult to obtain with a conventional form seal. This may explain the possibility to obtain an excellent seal and excellent pressure resistance.

According to the invention, the seal is a multilayer add-on seal that, when on the inside of the capsule shell, does not have a simple disk shape but that of a goblet with an axial edge, substantially cylindrical, the height of which is substantially of the same value as the thickness of the substantially flat part of the seal. This form seal can be, for example, a stamped or thermoformed disk then introduced into the bottom of the capsule shell. Advantageously, the form seal is obtained from a disk or a wafer cut in a multilayer strip with a diameter greater—approximately of two times its thickness—than the internal diameter of the shell at the level of the head, then pressed into the capsule by force, by means of a mandrel for example. Owing to the support layer, which gives its overall mechanical behavior to said set of adjacent layers, the seal is shaped without creation of folds that lead to leaks.

According to a preferred solution, after compression, the geometry of the seal is such that its periphery is not abutted against the inner peripheral surface of the shell head. In other words, the curvature radius R of the fillet connecting the center part of the seal and the axial peripheral edge, typically between is 0.5 mm and 2 mm, is greater than the curvature radius R′ of said shell in the zone where said head and said skirt connect. It is only during stoppering, when the head is compressed at least axially, that the peripheral part of the seal abuts on the inner surface of the periphery of the head of the shell.

During the stoppering operation, i.e. once the recipient has been filled, the capsule is crimped around the neck, the axial edge of the seal can not only be against the inner surface of the periphery of the head of the shell but it can also be deformed by axial elongation and radial shrinkage, if the capsule undergoes deformation on the periphery of the head of the shell that it transmits to the seal. This deformation can include for example, lateral compression, in the centripetal radial direction, due to the planetary passage of rollers or the combination of a necking and an axial traction which would result from the axial depression of an ring-shaped compression head.

The applicant noted that the deformation undergone during stoppering, in particular the combination of the necking, the elongation and the abutting against the head of the shell, significantly improved the conditions of intimate contact between the seal and the mouth of the recipient, thus the liquid and gas seal over an extended period of time, provided that the seal was properly deformed—i.e. without any fold—when it was placed in the capsule.

Advantageously, the skirt comprises, in its part closest to the head, an inner radial projection, typically an ring-shaped inner rib, forming a stop for the said axial edge of the said seal. Preferably, the said inner radial projection is placed at an axial distance from said head which was chosen notably based on said axial height h, such that said edge of the seal is blocked axially by said inner radial projection. Preferably, this distance is defined in such a way that the said seal remains constrained after being placed inside the said shell.

The shell can be metalloplastic or metallic, typically made of tin, or a tin alloy, is steel or aluminum, or aluminum alloy.

Advantageously, said seal has a thickness E ranging from 1 mm to 3 mm, and preferably, from 1.2 mm to 2.5 mm.

The set of adjacent layers can be formed by a multilayer film that is assembled to the resilient layer by bonding, lamination, welding or any other conventional means. As indicated above, each of the layers of the set of adjacent layers can fulfill several of the functions described in b2.1, b2.2 and b2.3. In addition, the order b2.1, b2.2 and b2.3 in which these layers are described is not an indication as to the positioning of the layers in relation to one another. The set of adjacent layers can also be formed by a layer (or a set of layers) covered on one of its faces by a thin covering, such as a coating applied by PVD (physical vapor deposition), CVD (chemical vapor deposition) or plasma assistance.

Advantageously, the seal has a symmetrical structure: two sets of identical adjacent layers are arranged in a symmetrical manner on either side of the resilient layer. The interest of a symmetrical structure resides in greater machinability of the seals, enabling them to be manipulated in any position before being placed inside the shell.

Advantageously, said resilient layer is an expanded polyethylene (EPE) layer having a density between 0.2 to 0.5 and preferably between 0.25 and 0.48.

The malleable support layer has a thickness chosen based on the thickness and the mechanical characteristics of the other layers so as to impart overall satisfactory mechanical behavior to the set of adjacent layers, guaranteeing in particular that no folds are created when the seal is introduced into the shell.

Said support layer can be metallic or organic. The applicant has indeed found that it was preferable that the layer not comprise a layer of cellulosic material is or of “Kraft” type paper. In such cases, the periphery of the seal nearly systematically creates folds making it difficult to obtain a good seal between the capsule and the mouth of the bottle. If the set of adjacent layers comprises a metallic layer as a support, this layer can also serve as a barrier layer. If the set of adjacent layers does not comprise a metallic layer, the support layer is chosen with a thickness substantially greater than that of the adjacent organic barrier layer. In this way, said barrier layer, generally rigid and fragile, can be more easily deformed without losing its properties.

Said outer layer is a flexible organic layer facilitating an intimate and impermeable contact with the material of the recipient. Advantageously, this outer layer has a low friction coefficient, typically below 0.25, preferably below 0.2, with the material of the bottle. Among the possible materials, rather a polyolefine, for example, a polyethylene (PE), possibly loaded with a slip additive, a polyvinylidene chloride (PVDC), a polyethylene terephtalate (PET) or even, preferably, a polyamide (PA) would be chosen. The applicant has indeed noted that a good tightness on a capped neck depended as much, if not more, on the ability of the seal to intimately match the shape of the mouth than the intrinsic properties of permeability of the component layers of the seal: it is of no use that a layer, such as a metallic layer, offers an excellent barrier to diffusion if the latter is not sufficiently malleable to match as close a possible the relief imposed by the micro-asperities of the material of the mouth so as to have an intimate contact with same. Plastic materials, and particularly polyamides, exhibit excellent behavior in this respect.

In certain embodiments of the invention, said layer of barrier material comprises a metallic layer, typically aluminum or tin or their respective alloys.

Other embodiments of the invention present seals more easy to recycle, made entirely or nearly entirely of plastic materials. In this case, said barrier layer can be a mineral such as silicium oxide SiOx deposited on one of the component is plastic layers of the seal. The barrier layer can also be an organic barrier material such as an ethylene vinyl alcohol copolymer (EVOH), a polyvinylidene chloride (PVDC), in particular a Saran, or even a polyamide (PA).

The seals can have several possible structures. The preferred structures comprise a core of said resilient layer, having a thickness typically between 1 and 3 mm, generally 2 mm, and, adjacent to at least one face of said core, a set of adjacent layers that is:

a) either a metalloplastic complex set, of P/Adh/M/Adh/P′ type or even of M/Adh/P/Adh/M′/Adh/P′ type, where P and P′ symbolize plastic materials, possibly different, M and M′ symbolize metals, possibly different, and Adh designates an adhesive layer suitable for the assembly of metallic layers and polymeric layers, typically made of polyurethane (PUR) or EAA (ethylene-acrylic acid copolymer), for example, PE/EAA/Sn/EAA/PVDC or PE/EAA/Al/EAA/PA for the first case and Al/EAA/PE/EAA/Al/EAA/PA for the second case;
b) or an entirely plastic set, for example a coextruded or bonded multilayer film of PE/EVOH/PE type or, preferably, a layer of polyamide (PA) covered by a think layer of silicium oxide SiOx (x near 2, typically between 1.5 and 1.8), having a thickness typically between 50 and 80 nm. In this last case, and particularly if the bottle is glass, the thin layer of silica is advantageously placed toward the resilient layer, typically of EPE, so as to leave the polyamide layer in contact with the mouth of the neck.

In another embodiment, said capsule comprises a metallic outer shell and an inner plastic insert, said insert being integral with said metallic shell, its bottom abutting against the head of the shell, in such a way that said form seal is no longer connected by force to said head but to the bottom of said insert.

Regardless of the embodiments considered, said shell can comprise a means to detect initial opening typically including a guarantee band attached by a plurality of bridges to an upper part of said shell, said guarantee band is remaining integral with said neck during initial opening causing said bridges to break. The skirt of the shell can also comprise at least one ring forming an ring-shaped radial projection, said ring being placed below said guarantee band or a line of weakening, so as to protect said guarantee band or said line of weakening when the skirt is crimped to the neck by the formation of a lower necking part. Said skirt can also externally comprise a plurality of axial splines to make it easier to grip the capsule manually when it is opened for the first time.

Another subject according to the invention is a method for manufacturing a stopper cap in which:
a) a shell is obtained or shaped which comprises a head and a skirt and has an internal diameter D at the top of the shell at the level of said head,
b) a disk made or shaped of multilayer material of diameter D′>D is procured or shaped, said disk being formed by cut-out, typically with a punch, a multilayer band, the difference between the diameter D′ of the disk and the internal diameter D of the shell typically being between half and double the thickness of said disk;
c) said disk is assembled to said shell by forcibly introducing said pastille into said shell by its opening, using an assembly device comprising a compressing die placed on said opening of said shell against its lower extremity, and a shaping punch of said disk, which by relative axial displacement of the punch in relation to the die, deforms said disk to form said form seal equipped with said axial edge and places said seal in the bottom of said shell.

Advantageously, the seal is formed by the passage of the peripheral edge of the disk between said punch and said die, then it is forced into the bottom of the shell by axial displacement of the punch in the shell and the edge of the seal is held in tension by a sliding contact between the outer surface of the axial edge and the inner well of the shell. Advantageously, the disk is transformed into a seal which is forced into the bottom of the shell in one single is axial movement of the punch, the die and the shell being kept stationary.

In order to axially block the seal in the head of the shell, the skirt can comprise, in its part closest to the head, referred to as the “upper part”, an inner radial projection, typically an ring-shaped groove, which forms a stop for the axial edge of said seal. Said seal is placed beyond said inner radial projection by force, between the head and the inner radial projection, the extremity of the axial edge abutting against said inner radial projection, the distance between the inner wall of the head and said inner radial projection being preferably defined such that said seal can be restrained.

If the capsule comprises an insert, this method also includes a step in which an insert forming a molded plastic part comprising a head and a skirt is procured, said disk is assembled with said insert instead of assembling it to said shell, so as to obtain said seal typically under stress assembled to said insert. Said insert can either be assembled to said shell before said seal is formed in said insert, or first assemble said seal to said insert, said insert thus equipped with said seal typically under stress, then being secured to said shell.

Another object of the invention is a method for stoppering the neck of a bottle, said neck comprising at least a mouth, an upper axial part adjoining said mouth of the neck and of outside diameter D1 and a counter-ring of outside diameter D3 forming a crimping shoulder with a lower part of diameter D3′<D3, the method in which:

a) a stoppering device is used comprising notably an axial compression end cap comprising two coaxial parts, one central part, referred to as the “axial compression head”, the other peripheral part, referred to as the “ring-shaped end cap” or “necking ring”, these two parts may be integral or mobile in relation to one another and a crimping means, typically a roller;
b) a stopper cap according to the invention is used,
c) said capsule is placed on said neck, said capsule, typically cylindrical, having an internal diameter adapted to the dimensions of said neck, such that said head of said capsule can axially abut against said mouth, said form seal being interposed between said head and said mouth,
d) said axial compression ram with its center part and its peripheral part are displaced together in the direction of the capsule, so as to compress the head of the shell and the form seal by flattening the latter against said mouth;
e) an additional axial displacement is made of the sole peripheral part of the compression end cap in such a way that the part of said capsule opposite said upper axial part of the neck undergoes necking by passing from an external diameter Do to an external diameter D′o<Do, said necking leading to the radial compression of said axial edge of the seal against at least a fraction of the upper axial part of the neck;
f) said crimping means is applied radially against said skirt so as to push the metal of said skirt under said shoulder.

This method applies mainly to screw type capsules. In this case, the neck of the recipient equally comprises, between the upper axial part and the counter-ring, a threaded part comprising at least a screw thread groove, of external diameter D₂>D₁ and of diameter D′₂<D₂ in the grove bottom, and the stoppering device also has a thread forming tool, such that between step e) and step f), said thread forming tool is applied radially against the skirt of the capsule so as push the metal of said skirt into said groove on the threaded part of the neck, so as to thus form a metal skirt with a thread.

Advantageously, the necking rate D′o/Do is between 0.91 and 0.96, preferably between 0.92 and 0.95, and is typically 0.94.

Another object of the invention is a capped bottle obtained by the previous method.

Another object of the invention is the use of stopper caps according to the invention or obtained by the method according to the invention, to stop bottles containing a liquid under pressure.

All the figures relate to the invention.

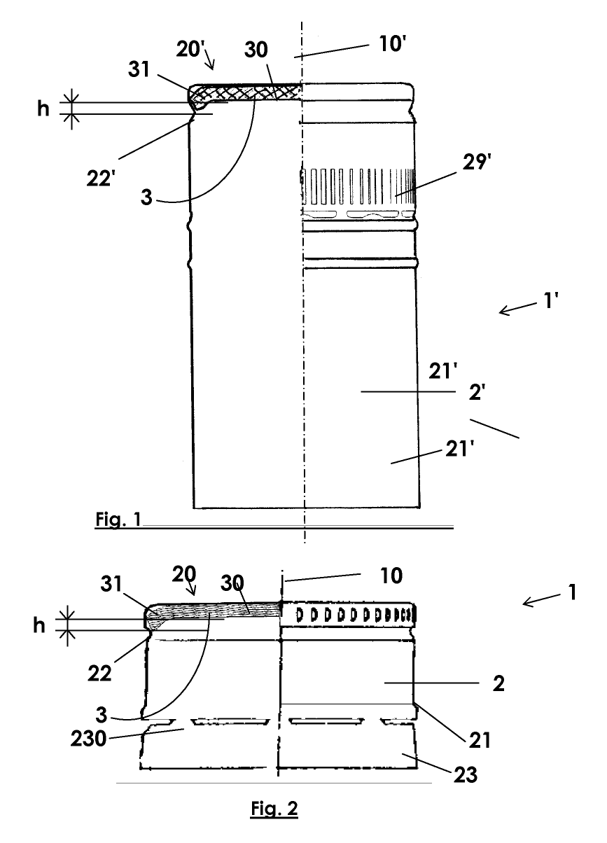

FIG. 1 represents a stopper cap (1′) with a so-called long skirt, its left-hand side being an axial cross-sectional view in a vertical plane along its axial direction (10′), and its right-hand side being a side view.

FIG. 2 represents a stopper cap (1) with a so-called short skirt, its left-hand side being an axial cross-sectional view in a vertical plane along its axial direction (10), and its right-hand side being a side view.

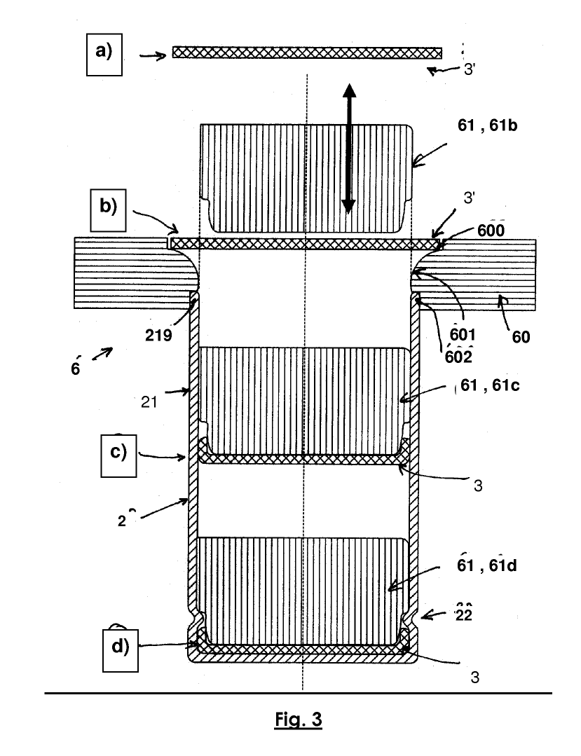

FIG. 3 is a schematic representation, along an axial cross-section, of the assembly of a seal disk (3′) to a shell (2).

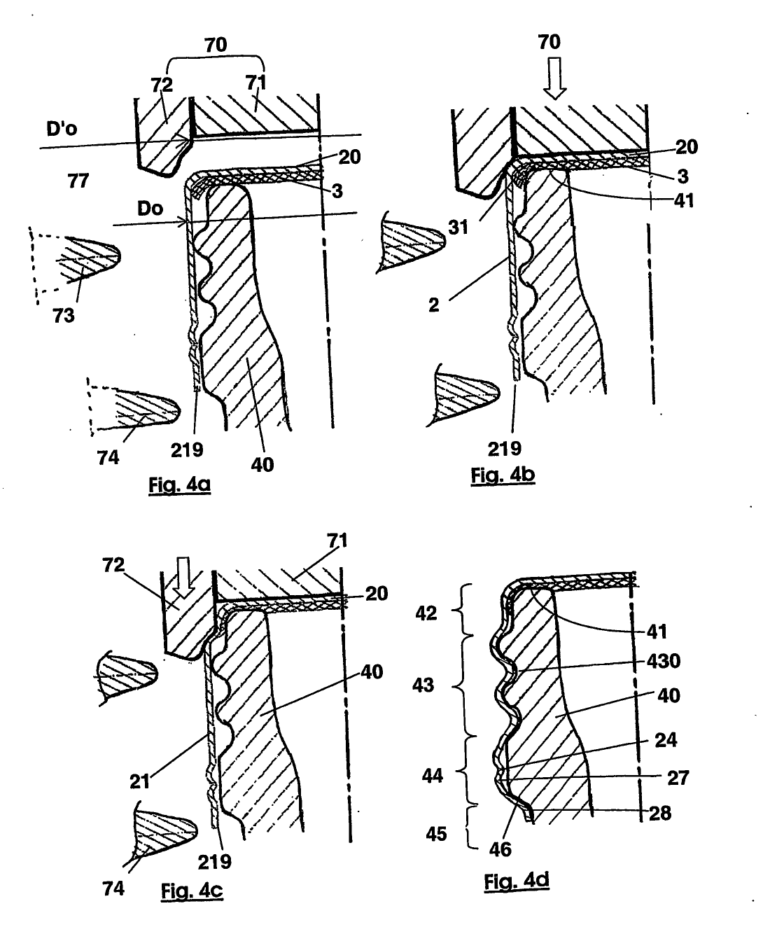

FIGS. 4a, 4b and 4c are left-hand axial half-sectional views which represent the first steps of the stoppering operation by which the capsule (1) is secured to the neck (40) of a bottle (4). FIG. 4d represents a left-hand axial half-sectional view of the same head equipped with its capsule after formation of the thread and crimping of the lower end (219).

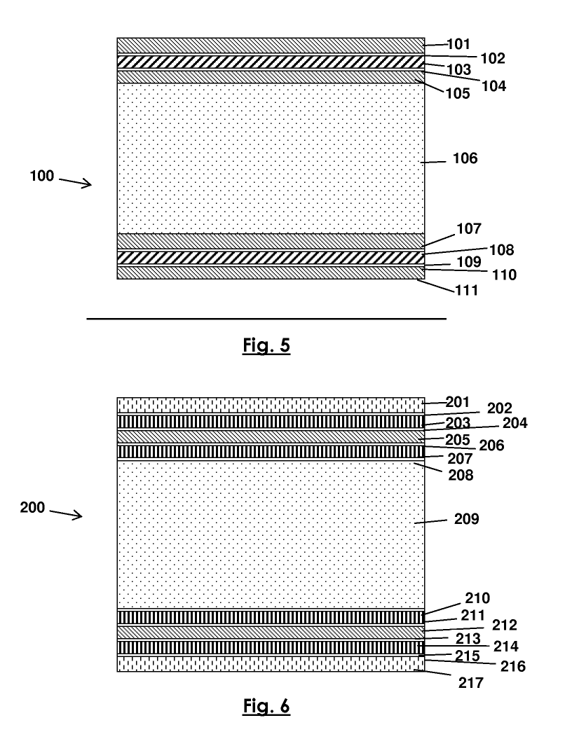

FIGS. 5 to 8 are schematic axial cross-section representations of various multilayer seal structures according to the invention, the various layers being possibly interlinked by an adhesive layer “Adh”.

FIG. 9 represents an axial cross-sectional view on another capsule embodiment (1″) according to the invention.

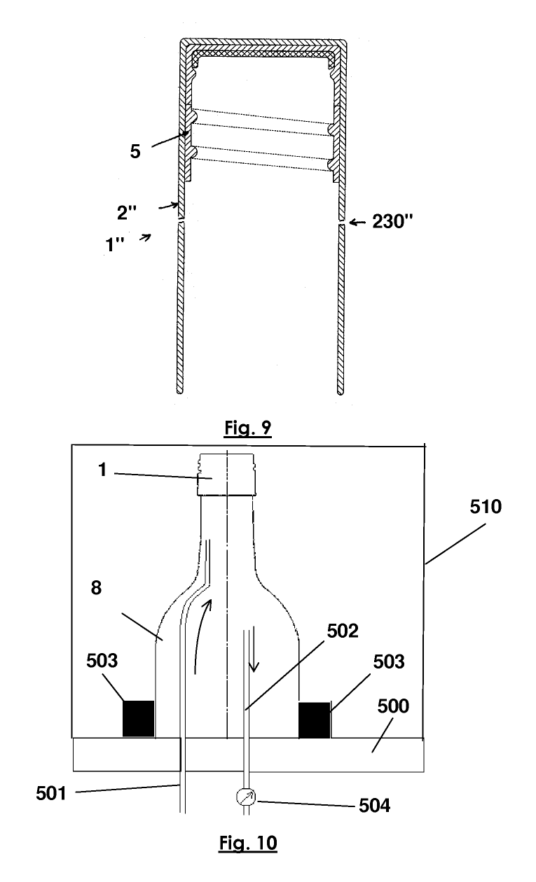

FIG. 10 schematically represents a device enabling the tightness of recipients is to be checked: the capped recipients with capsules according to the invention give far superior tightness results than those obtained with the capsules from the prior art.

### EXAMPLES OF EMBODIMENTS

### Capsules Comprising a Multilayer Add-on Form Seal According to the Invention (FIGS. 1, 2 and 9)

FIG. 1 represents a long skirt stopper cap 1′ having an axial direction 10′. This capsule includes a shell 2′, comprised of a head 20′ and a skirt 21′, and a seal 3 arranged inside the shell. The skirt 21′ can also externally include a plurality of axial splines 29′ to make it easier to grip the capsule manually when it is opened for the first time.

The seal 3 is a form seal pressed inside the shell 2′ by force. It has a center part 30 typically plane and perpendicular to the axial direction 10 and an axial peripheral edge 31 connected to said center part 30. Its axial height h, measured from the level of the surface of the center part of the seal, is essentially equal to the thickness of the center part 30, between 0.5 and 2 mm.

Said seal 3 is a multilayer form seal made from a disk 3′ cut from a multilayer strip, a few structures of which are given in the example below. It is blocked axially by an inner radial projection: the ring-shaped groove 22.

FIG. 2 represents a short skirt stopper cap 1, having an axial direction 10. This capsule includes a shell 2, comprising a head 20 and a skirt 21, and a seal 3, identical to the previous seal and arranged in the same manner inside the shell. It is also blocked axially by an inner radial projection or inner ring-shaped rib 22. The bottom of the skirt is equipped with a guarantee band 23 separated from the rest of the skirt by a line of frangible bridges 230.

FIG. 9 represents an axial cross-sectional view of another stopper cap embodiment (1″) according to the invention. In this embodiment, a threaded insert 5 is assembled to the metal shell 2″, the form seal 3 being assembled to the threaded insert 5. The bottom of the skirt is also separated from the rest of the skirt by a line of frangible bridges 230″.

### Multilayer Seal Structures (FIGS. 5 to 8)

The following examples describe various band structures produced to obtain the disks used to make the seals according to the invention.

FIG. 5 illustrates a symmetrical multilayer structure 100 where the core 106 made of expanded polyethylene is flanked on both its sides by a multilayer film PE (101, 111)/Adh (102, 110)/PVDC (103, 109)/Adh (104, 108)/PE (105, 107). The Adh symbol designates an adhesive layer, typically made of polyurethane or EVA (ethylene vinyl acetate copolymer). Each portion of film (101 to 105, 107 to 111) is conjoined by thermowelding to a face of the EPE core 106. Optionally, the external PE layer (101, 111) is loaded with a food-grade compatible slip additive, such as an oleamide or an erucamide.

FIG. 6 also illustrates a symmetrical multilayer structure where the EPE core 209 is flanked by two portions of a like film arranged symmetrically, said film being a PA (201, 217)/Adh (202, 216)/Al (203, 215)/Adh (204, 214)/PE (205, 213)/Adh (206, 212)/Al (207, 211) complex, where Al designates an aluminum alloy layer, PE a polyethylene layer, typically PE.BD and Adh an adhesive layer, typically made of EAA (ethylene-acrylic acid copolymer). Each portion of film (201 to 207, 211 to 217) is conjoined by lamination to a face of the EPE core 209 by interposing an adhesive layer (208, 210), typically also made of EAA.

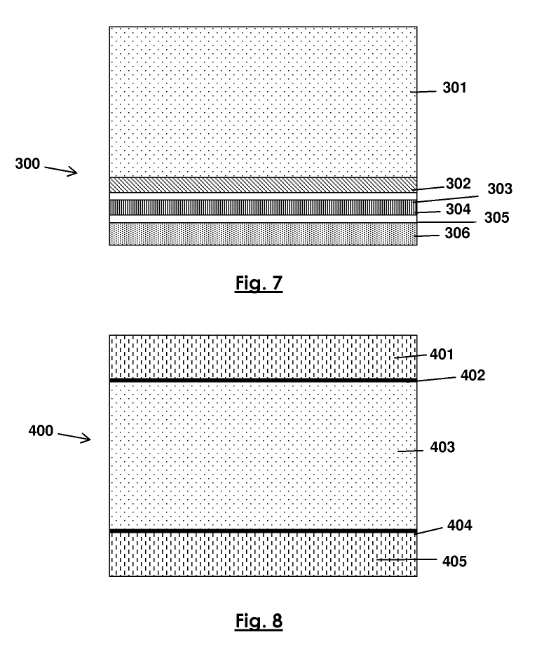

FIG. 7 illustrates an asymmetrical multilayer structure where one of the faces is of the EPE core 301 is associated with a film having the following structure: PE (302)/Adh (303)/Sn (304)/Adh (305)/PVDC (306) where “Adh” represents an adhesive layer, typically polyurethane, PVDC designates a polyvinylidene chloride layer, preferably a Saran, Sn designates a metallic layer made of a tin alloy, and PE designates a PE polyethylene layer. The film is conjoined on the core by welding having the PE layer 302 on the core side 301.

FIG. 8 again illustrates a symmetrical multilayer structure where the EPE core 403 is flanked by two portions of a PA polyamide band (401, 405) covered on one of its faces by a thin layer of silica (402, 404). These portions are arranged symmetrically, the silica coating being oriented toward the EPE core 403. The silica was deposited by plasma assistance on the polyamide band.

### Multilayer Add-on Seal Shaping Method (FIG. 3)

FIG. 3 is a schematic representation, along an axial cross-section, of the assembly of a seal disk 3′ to a shell 2.

Four steps, a), b), c) and d) of the evolution of the seal disk 3′ in the assembly device 6 cooperating with a shell (2) have been illustrated:
in step a), the seal disk 3′ is represented individually;
in step b), the seal disk 3′ is represented placed on the die 60, in its upper hollow part 600, the punch 61 (in state 61b) being placed above the seal disk 3′, while the lower hollow part 602 of the die 60 cooperates with the lower end 219 of the skirt 21 of the shell 2;
in step c), the punch 61 (in state 61c) is lowered to mid-height in the skirt 21 of the shell 2 and pushes toward the bottom the form seal 3 shaped under force while being folded along a circular line as it passes through the die 60;
in step d), the punch 61 (in state 61d) is lowered to the bottom of the skirt 21 of the shell 2 and the form seal 3 is pushed to the bottom of the shell below the radial projection 22.
   Stoppering Method with a Capsule According to the Invention (FIGS. 4a, 4b, 4c, 4d)

The capsule chosen to illustrate the various steps of the stoppering operation in FIGS. 4a) to 4d) is a short skirt screw type capsule identical to that illustrated in FIG. 2, the inner radial projection 22, for trapping the seal axially, although not represented so as not to overload the drawings. The screw thread of this capsule is formed only during the stoppering operation. The various parts (70=71+72, 73, 74) of the stoppering device (7) were only represented partially.

FIG. 4a) represents the capsule 1 being placed on the neck 40 opposite the stoppering device 7, the capsule 1 having an internal diameter essentially equal, although slightly greater, to the largest external diameter of said neck 40. The neck 40 is threaded. FIG. 4d) shows that it is comprised of an upper axial part 42 surmounted by a top part called the “mouth” 41, a threaded part 43, having a groove 430, a projecting counter-ring 44 in relation to the lower necking part 45, the shoulder 46 between the counter-ring 44 and the lower necking part 45 used as an attachment support for the capsule 1 during crimping. The stoppering device 7 namely has a roller 73 and an axial compression end cap 70 comprised of at least two coaxial parts: the axial compression head 71 and the ring-shaped end cap 72, also referred to as the “necking ring”. The axial compression head 71 and the ring-shaped end cap 72 can be integral or mobile in relation to one another.

FIG. 4b represents the first axial compression phase of the capsule 1 on the neck 40 owing to the axial pressure exerted by the compression end cap 70 of the stoppering device 7, the axial compression head 71 and the ring-shaped end cap 72 being maintained integral during this phase. Typically, during this is phase, the axial force exerted by the end cap 70 is roughly 50 daN for a capsule measuring 30 mm in diameter. The seal 3 is flattened and indented at the mouth 41, its axial edge 31 is pressed against the inner surface of the head 20 of the shell 2.

FIG. 4c) represents the second axial compression phase of the capsule 1 on the neck 40 owing to the axial pressure exerted by the ring-shaped end cap 72 alone, resulting in the necking of the upper part of the skirt 21 and the edge of the head 20 against the upper axial part 42 of the neck 40. This has the effect to essentially extend the skirt 2, the lower end 219 of which reaches the lower necking part 45 of the neck for crimping of the capsule. Typically, during this phase, the axial force exerted by the ring-shaped end cap 72 is roughly 160 daN for a capsule of 30 mm in diameter.

FIG. 4d represents the capsule 1 crimped on the neck 40. The thread rolling tool 73 was used to push the typically metallic skirt into the threads 430 on the threaded part 43 of the neck 40, and the subsequent action of the crimping roller 74 which folded the lower end 219 of the skirt 21 under the counter-ring 44, so as to crimp the capsule to the neck. The capsule has a ring 27 forming an ring-shaped radial projection, placed below a line of weakening 24, in such a way that said line of weakening was protected when the skirt 21 was crimped to the neck 40 by the formation of the lower necking part 28.

### Measurement of the Tightness of the Recipient (FIG. 10)

The tightness of a capsule is expressed not only according to the intrinsic barrier properties of the seals used: the contact of the seal on the mouth of the neck plays a primordial role and it is imperative to design a test that is representative of the actual tightness conditions of the necks capped. For this reason, the applicant has developed the following tightness test:

a) the body of a capped bottle is cut to remove its lower part. The cut must be clean and as plane as possible so as to be able to place the upper part of the bottle 8 equipped with its capsule 1 on a plane plate 500, typically made of stainless steel, in a zone where it is perforated to allow two tubes 501 and 502 to pass through it. The connection between the lower end of the bottle and the stainless steel plate 8 is rendered perfectly hermetic by a thick bead 503 of epoxy resin (typically 20 mm). A gas of controlled purity, typically pure argon or pure nitrogen, is introduced inside the bottle via the tube 501. This gas is exhausted by the tube 502 which is connected to a means 504 to measure the quantity of foreign atoms (typically oxygen atoms) which have entered the bottle (Oxtran type machines). The assembly is placed in a chamber 510, which is then filled with oxygen. In order to correctly evaluate the tightness of the stoppering, several days are required before measuring the quantity of oxygen that has infiltrated into the bottle.

Tests were conducted on various STELVIN (registered trademark of the applicant) 30H60 capsules equipped with seals of 28.5 mm in diameter and 2 mm thick.

In particular:
a seal A that has a structure identical to that in FIG. 6:
   resilient layer made of EPE400 (85 shores)
   b2) a set of adjacent layers: PE/Al (12 μm)/PE/Al (12 μm)/PA (40 μm), the layers being interconnected by a layer of EAA type adhesive material.
a seal B which has the following structure:
   resilient layer made of EPE400 (85 shores)
   b2) a set of adjacent layers: PE/PA SiOx (15 μm)/PA (40 μm), the layers being interconnected by a layer of EAA type adhesive material.

The capsules were crimped onto the necks of bordelaise bottles. The bottles were placed in a chamber containing oxygen for 40 days.

The analyses were conducted with a dry gas (Argon) and at ambient temperature.

### Results: Oxygen Permeability

| | | Flow measured (cc |
|---|---|---|
| Seal | Test | O2/day) per capsule |
| A | A.1 | 0.00024 |
| | A.2 | 0.00003 |
| | A.3 | 0.00002 |
| B | B.1 | 0.00017 |
| | B.2 | 0.00012 |
| | B.3 | 0.00010 |
| | B.4 | 0.00011 |

Certain results for seal A are very good but overall the results are rather dispersed. With this type of seal, a capsule permeability value in the order of 10⁻⁴ cc O₂/day can be defined.

Seal B has the most homogenous results. With this type of seal, a capsule permeability value in the order of 1.3⁻¹⁰ cc O₂/day can be defined.

These values, related to the surface of the seal, correspond to a permeability value in the order of 1.5 cc O₂/m²/d/atmosphere. They are near but higher than the intrinsic values of oxygen permeability of plastic “barrier” films containing EVOH or PVDC, for example. This clearly shows that capsule tightness essentially depends on the nature of the contact of the seal on the mouth of the bottle neck: it is of no use to have organic seal with excellent is barrier properties if its mechanical behavior does not enable it to establish intimate contact with the glass of the recipient.

1. A stopper cap, having an axial direction, comprising a shell, with a head essentially perpendicular to said axial direction and a skirt, and a seal arranged inside said shell, said stopper cap being designed to tightly seal the neck of a recipient by axial and lateral compression of said capsule and said seal against said neck, characterized in that:
a) said seal is a form seal having a center part, typically plane and perpendicular to said axial direction, surrounded by an axial peripheral edge the axial height h of which, measured between the level of the inner surface of said center part and the end of said peripheral edge is at least equal to ¼ the thickness of said center part;
b) said form seal is a multilayer seal comprising at least:
b1) a resilient layer made of a material capable of sustaining extensive deformation under compression while remaining in its elastic range;
b2) a set of adjacent layers, comprising at least the following layers, a same layer possibly fulfiling more than one of the functions described below:
b2.1) a layer made of a material to form a barrier against the diffusion of gases;
b2.2) a malleable support layer to provide said set of adjacent layers a global malleable mechanical property, enabling, in association with said resilient layer, said form seal to be shaped without the creation of folds;
b2.3) an outer layer made of plastic material with the function of presenting an outer surface intended to be indented under the effect of said axial compression of said capsule and of said seal against said neck so as to match, at the contact, the shape of the mouth of said neck.

2. The stopper cap according to claim 1 in which the material of said outer layer forms with the material of the recipient, a contact with a low friction coefficient, typically a Coulomb coefficient less than 0.25, preferably less than 0.2.

3. The stopper cap according to claim 1 in which said height h is between 25% and 100% of the thickness of said center part.

4. The stopper cap according to claim 1 characterized in that the curvature radius R of the fillet connecting center part of the seal and the axial peripheral edge, typically between 0.5 mm and 2 mm, is greater than the curvature radius R′ of said shell in the zone where said head and said skirt connect.

5. The stopper cap according to claim 1 characterized in that said skirt also has, in its part closest to said head, an inner radial projection forming a stop for said axial edge of said seal.

6. The stopper cap according to claim 5 in which said inner radial projection is placed at an axial distance from said head that was chosen notably based on said axial height h, such that said seal remains constrained after being placed inside said shell.

7. The stopper cap according to claim 1 in which said form seal has a thickness ranging from 1 mm to 3 mm, and preferably from 1.2 mm to 2.5 mm.

8. The stopper cap according to claim 1 in which said resilient layer is made of an expanded polymeric material, an expanded polystyrene (EPS), an expanded polypropylene (EPP) or an expanded polyethylene (EPE) or even an elastomeric material, typically a polymer comprising butyl or nitrile groups, or a thermoplastic elastomer such as SIS (styrene isoprene styrene), SBS (styrene butadiene styrene) or SEBS (styrene ethylene/butylene styrene).

9. The stopper cap according to claim 8 in which said resilient layer is an expanded polyethylene (EPE) layer having a density between 0.2 to 0.5 and preferably between 0.25 and 0.48.

10. The stopper cap according to claim 1 in which said material used to form a barrier against the diffusion of gases, is a metal or a metal alloy such as aluminum or an aluminum alloy, steel, tin or a tin alloy, an organic material such as polyvinylidene chloride (PVDC), a ethylene vinyl alcohol copolymer (EVOH) or even a mineral material such as silicon oxide (SiOx).

11. The stopper cap according to claim 1 in which said malleable support layer is a material such as a metal or metal alloy, typically aluminum or an aluminum alloy, steel, tin or a tin alloy, or a thermoplastic material such as polyolefine (PE or PP), a polyethylene terephtalate (PET), or a polyamide (PA).

12. The stopper cap according to claim 1 in which said set of adjacent layers is formed by a layer (or a set of layers) covered on one of its faces by a thin covering, such as a coating applied by PVD, CVD or plasma assistance.

13. The stopper cap according to claim 1 in which said form seal has a symmetrical structure, i.e. where two sets of identical adjacent layers are arranged in a symmetrical manner on either side of said resilient layer.

14. The stopper cap according to claim 1 in which said form seal is free of a layer of cellulosic material or “Kraft paper” type paper.

15. The stopper cap according to claim 1 in which said outer layer is of polyamide.

16. The stopper cap according to claim 1 in which said seal has a core comprised of said resilient layer, of thickness typically between 1 and 3 mm, and, adjacent to at least one face of said core, a set of adjacent layers which is a set metalloplastic complex set of P/Adh/M/Adh/P′ type or M/Adh/P/Adh/M′/Adh/P′ type, where P and P′ symbolize possibly different plastic materials, M and M′ symbolize possibly different metals, and Adh designates an adhesive layer for assembling the metallic layers and polymeric layers.

17. The stopper cap according to claim 16 in which said set of adjacent layers is an Al/EAA/PE/EAA/Al/EAA/PA complex where Al designates an aluminum or aluminum alloy layer, PE designates a polyethylene and PA designates the polyamide layer oriented toward the outside.

18. The stopper cap according to claim 1 in which said seal has a core comprised of said resilient layer, of thickness typically between 1 and 3 mm, and, adjacent to at least one face of said core, a set of adjacent layers made entirely of plastic materials, such as a film polyethylene (PE)/copolymer (ethylene vinyl alcohol) (EVOH)/polyethylene (PE), the polyethylene layer oriented opposite the core being preferably loaded with a slip additive.

19. The stopper cap according to claim 1 in which said seal has a core comprised of said resilient layer, of thickness typically between 1 and 3 mm, and, adjacent to at least one face of said core, a set of adjacent layers consisting of a layer of polyamide (PA) covered by a layer of silicon oxide SiOx, the said layer of silica being placed toward the said core.

20. The stopper cap according to claim 1, in which said shell is a metallic shell, typically made of tin or tin alloy, steel or aluminum or aluminum alloy.

21. The stopper cap according to claim 1 in which said shell is made of plastic material.

22. The stopper cap according to claim 1, modified in that said capsule has a metallic outer shell and an inner plastic insert, said insert being fixed to said metallic shell, its bottom abutting against the head of the shell, in such a way that said form seal is no longer connected by force to said head but to the bottom of said insert.

23. The stopper cap according to claim 1, in which said shell has a means to detect first opening typically including a guarantee band attached by a plurality of bridges to an upper part of said shell, said guarantee band remaining integral with said neck during initial opening causing said bridges to break.

24. The stopper cap according to claim 1, in which the skirt of the shell has at least a ring forming an ring-shaped radial projection, said ring being placed below a line of weakening, so as to protect said line of weakening when the skirt is crimped to the neck by the formation of a lower necking part.

25. The stopper cap according to claim 1, in which said skirt externally has a plurality of axial splines so as to make it easier to grip the capsule manually when it is opened for the first time.

26. A method for manufacturing a stopper cap characterized in that:
a) a shell is procured or shaped which has a head and a skirt and has an internal diameter D at the top of the shell at the level of said head,
b) a disk made of multilayer material of diameter D′>D is procured or shaped, said disk being formed by cut-out, typically with a punch, a multilayer band, the difference between the diameter D′ of the disk and the internal diameter D of the shell typically being between half and the double the thickness of said disk;
c) said disk is assembled to said shell by forcibly introducing said pastille into said shell by its opening, using an assembly device comprising a compressing die placed on said opening of said shell against its lower end, and punch to shape said disk, which by relative axial displacement of the punch in relation to the die, deforms said disk to form said form seal equipped with said axial edge and places said seal in the bottom of said shell.

27. The method according to claim 26 in which said disk is a multilayer disk comprising at least:
b1) a resilient layer made of a material capable of sustaining extensive deformation under compression while remaining in its elastic range, preferably an expanded polyethylene;
b2) a set of adjacent layers, comprising at least the following layers, a same layer possibly fulfilling more than one of the functions described below:
b2.1) a layer made of a material to form a barrier against the diffusion of gases;
b2.2) a malleable support layer to provide said set of adjacent layers a global malleable mechanical property, enabling, in association with said resilient layer, said disk to be shaped without the creation of folds;
b2.3) an outer layer made of plastic material with the function of presenting an outer surface intended to be indented under the effect of the axial compression of said seal against said neck exerted during stoppering, so as to match, at the contact, the form of the mouth of said neck.

28. The method according to claim 27 in which the material of said outer layer is chosen so that it forms, with the material of the recipient, a contact with a low friction coefficient, typically a Coulomb coefficient less than 0.25, preferably less than 0.2.

29. The method according to claim 26 in which said disk is transformed into a form seal then placed under force in the bottom of said shell in a single axial movement of the punch, the die and the shell being kept stationary.

30. The method according to any claim 26 in which said skirt has, in its part closest to said head, an inner radial projection, which forms a stop for the axial edge of said seal and in which said seal is placed by force beyond said inner radial projection, between said head and said inner radial projection, the end of the axial edge abutting against said inner radial projection, the distance between the inner wall of said head and said inner radial projection being defined such that said seal can be maintained constrained.

31. The method according to any claim 26, modified in that an insert forming a molded plastic part comprising a head and a skirt is used, said disk is assembled with said insert instead of assembling it to said shell, so as to obtain said seal typically under stress assembled to said insert.

32. A stoppering method of the neck of a bottle, said neck comprising at least a mouth, an upper axial part adjoining said mouth of the neck and a counter-ring forming a crimping shoulder with a lower part, the method in which:
a) a stoppering device is used comprising notably an axial compression end cap comprising two coaxial parts, one central part, referred to as the “axial compression head”, the other peripheral part, referred to as the “ring-shaped end cap”, these two parts may be integral or mobile in relation to one another and a crimping means, typically a roller;
b) a stopper cap is procured according to claim 1,
c) said capsule is placed on said neck, said capsule, typically cylindrical, having an internal diameter adapted to the dimensions of said neck, such that said head of said capsule can axially abut against said mouth, said form seal being interposed between said head and said mouth,
d) said axial compression ram with its center part and its peripheral part integral is displaced in the direction of the capsule, so as to compress the head of the shell and the form seal by flattening the latter against said mouth;
e) an additional axial displacement is made of the sole ring-shaped end cap in such a way that the part of said capsule opposite said upper axial part of the neck undergoes a reduction by passing from an external diameter Do to an external diameter D′o<Do, said reduction leading to the radial compression of said axial edge of the seal against at least a fraction of said upper axial part of the neck;
f) said crimping means is applied radially against said skirt so as to push the metal of said skirt under said shoulder.

33. The stoppering method according to claim 32 in which the necking rate D′o/Do is between 0.91 and 0.96, preferably between 0.92 and 0.95.

34. A capped bottle obtained by the method according to claim 32.

35. (canceled)
